(19) United States
(12) Patent Application Publication
(10) Pub. No.: US 2020/0291877 A1
(43) Pub. Date: Sep. 17, 2020

(54) AGGRESSIVE THERMAL HEATING TARGET STRATEGY BASED ON NOX ESTIMATED FEEDBACK

(71) Applicant: GM Global Technology Operations LLC, Detroit, MI (US)

(72) Inventors: Michael A. Smith, Clarkston, MI (US); Po-I Lee, Rochester Hills, MI (US); Richard A. Barkman, Royal Oak, MI (US); Eugene V. Gonze, Pinckney, MI (US)

(21) Appl. No.: 16/299,792

(22) Filed: Mar. 12, 2019

(51) Int. Cl. F02D 35/02; F01P 7/14; F01P 3/02

(52) U.S. Cl. CPC F02D 35/026; F01P 7/14; F01P 2037/00; F01P 2025/31; F01P 2003/021; F01P 3/02

(57) ABSTRACT

A method for controlling an engine thermal target setpoint, includes: identifying in a first step an initial NOx integral at an initial calculated cylinder wall temperature and a thermal set point of an engine coolant; initiating a command in a second step to change the initial cylinder wall temperature and to change the thermal set point of the engine coolant; creating in a third step a new NOx integral at a new cylinder wall temperature and a modified thermal set point of the engine coolant; and comparing in a fourth step: is (the new NOx integral minus the initial NOx integral) greater than a predefined minimum threshold; and is (the new NOx integral minus the initial NOx integral) less than a predefined maximum threshold.

The present disclosure relates to vehicle active thermal control systems for tracking and improving efficiency.

Automobile vehicle engines commonly have pre-programmed operating condition ranges that improve fuel and operating efficiency. Efficiency can be increased in two ways, by increasing a peak combustion temperature, or by lowering an exhaust temperature. Vehicle engines have their highest temperature conditions occurring local to the cylinder heads. Peak combustion temperature can be increased until engine “knock” begins to occur. To protect the engine against the occurrence of engine knock manufacturers commonly predetermine a maximum allowable cylinder head temperature that prevents engine knock and select an engine coolant temperature set point which prevents local coolant boiling in the coolant jacket surrounding the cylinders and limits cylinder head temperature to prevent engine knock at vehicle operating conditions. This approach protects the engine for maximum engine and ambient conditions such as for operation in high temperature environments, but at the expense of maximum fuel efficiency which could be obtained by changing the coolant set point for operation during normal or cold ambient driving conditions.

Thus, while current vehicle engine control systems achieve their intended purpose, there is a need for a new and improved system and method for controlling vehicle engine efficiency.

### SUMMARY

According to several aspects, a method for controlling an engine thermal target setpoint includes: identifying in a first step an initial NOx integral at a calculated initial cylinder wall temperature and a thermal set point of an engine coolant; initiating a command in a second step to change the cylinder wall temperature and to change the thermal set point of the engine coolant; and creating in a third step a new NOx integral at a new cylinder wall temperature and a modified thermal set point of the engine coolant.

In another aspect of the present disclosure, the method includes comparing in a fourth step: is (the new NOx integral minus the initial NOx integral) greater than a predefined minimum threshold.

In another aspect of the present disclosure, the method includes comparing in the fourth step: is (the new NOx integral minus the initial NOx integral) less than a predefined maximum threshold.

In another aspect of the present disclosure, the method includes generating a command signal to decrease the thermal set point of the engine coolant if the response to the comparisons performed in the fourth step is YES.

In another aspect of the present disclosure, the method includes generating a command signal to increase the thermal set point of the engine coolant if the response to the comparisons performed in the fourth step is NO.

In another aspect of the present disclosure, the method includes limiting the predefined maximum threshold to prevent localized boiling of the engine coolant in a cylinder cooling jacket and knock of an engine.

In another aspect of the present disclosure, the method includes incorporating an output signal from a NOx sensor to calculate the initial cylinder wall temperature, the initial NOx integral, and the new NOx integral.

In another aspect of the present disclosure, the method includes estimating a NOx level output from an engine to calculate the initial cylinder wall temperature.

In another aspect of the present disclosure, the method includes tracking NOx changes and applying the NOx changes to data saved in a memory to calculate cylinder wall maximum temperatures.

In another aspect of the present disclosure, the method includes generating predicted ideal cylinder wall temperature targets based on the integrated NOx changes defined as differences between the new NOx integral and the initial NOx integral.

According to several aspects, a method for controlling an engine thermal target setpoint, includes: identifying in a first step an initial NOx integral at an initial calculated cylinder wall temperature and a thermal set point of an engine coolant; initiating a command in a second step to change the initial cylinder wall temperature and to change the thermal set point of the engine coolant; creating in a third step a new NOx integral at a new cylinder wall temperature and a modified thermal set point of the engine coolant; and comparing in a fourth step: is (the new NOx integral minus the initial NOx integral) greater than a predefined minimum threshold; and is (the new NOx integral minus the initial NOx integral) less than a predefined maximum threshold.

In another aspect of the present disclosure, the method further includes calculating the initial cylinder wall temperature using NOx data saved in a memory.

In another aspect of the present disclosure, the method further includes predicting the modified thermal set point using NOx data from the memory.

In another aspect of the present disclosure, the method further includes calculating the initial cylinder wall temperature, the initial NOx integral, the new NOx integral and the modified thermal set point using output signals from a NOx sensor and NOx data saved in a memory.

In another aspect of the present disclosure, the initial NOx integral and the new NOx integral are directly proportional to a peak cylinder wall temperature.

In another aspect of the present disclosure, the method further includes repeating the first through the fourth steps to identify if further improvement in fuel economy is available by increasing a cylinder wall temperature.

In another aspect of the present disclosure, the method further includes repeating the first through the fourth steps to identify if the cylinder wall temperature has reached a maximum allowable cylinder wall temperature based on a NOx production of an engine.

According to several aspects, a system for controlling an engine thermal target setpoint includes an initial NOx integral determined at a calculated initial cylinder wall temperature and a thermal set point of an engine coolant. A command is generated to change the cylinder wall temperature and to change the thermal set point of the engine coolant. A new NOx integral at a new cylinder wall temperature and a modified thermal set point of the engine coolant are created following the command. A first determination identifies if the new NOx integral minus the initial NOx integral is greater than a predefined minimum threshold; and a second determination identifies if the new NOx integral minus the initial NOx integral is less than a predefined maximum threshold.

In another aspect of the present disclosure, a NOx sensor generates an output signal defining a NOx level in an engine exhaust, the initial NOx integral, and the new NOx integral.

In another aspect of the present disclosure, an engine controller calculates an estimated NOx output using data saved in a memory.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic presentation of an engine thermal target setpoint system according to an exemplary aspect;

FIG. 2 is a flow diagram of an algorithm for carrying out steps for operation of the system of FIG. 1;

FIG. 3 is a graph of integrated fuel data used by the system of FIG. 1; and

FIG. 4 is a graph of NOx data used by the system of FIG. 1.

### DETAILED DESCRIPTION

The following description is merely exemplary in nature and is not intended to limit the present disclosure, application, or uses.

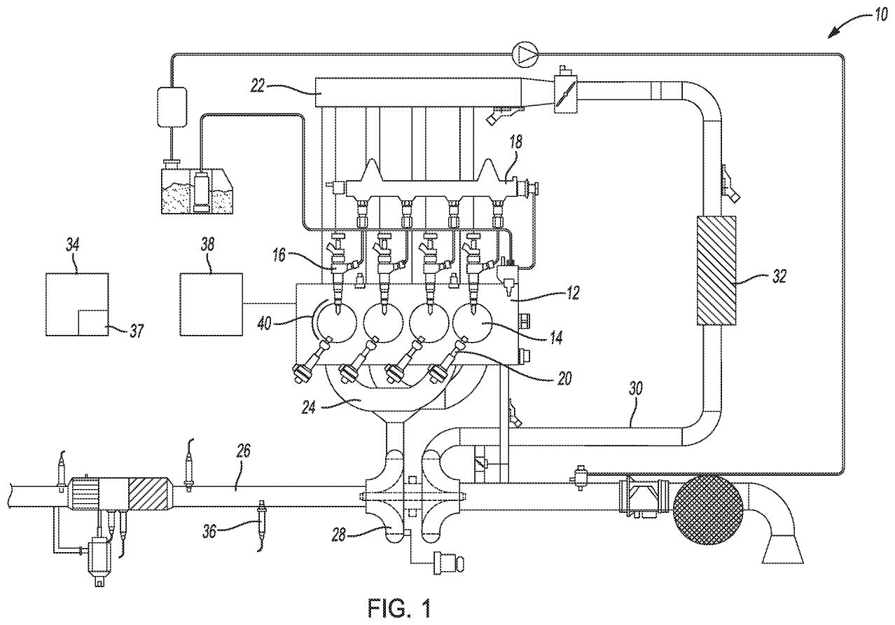

Referring to FIG. 1, an engine thermal target setpoint system 10 includes an engine 12 having multiple cylinders 14. The engine 12 is not limited to four cylinders 14 as shown and can have six or eight cylinders within the scope of the present disclosure. The cylinders 14 individually receive a fuel such as gasoline or E85 ethanol fuel blend from a fuel injector 16. A fuel header 18 can be provided which distributes fuel to the individual fuel injectors 16. A fuel ignitor 20 such as a spark plug is provided in the cylinders 14 to ignite a fuel and air mixture, with the air being delivered from an intake manifold 22.

Exhaust gas is discharged from the cylinders 14 into an exhaust manifold 24 which is delivered into an exhaust line 26. A turbocharger 28 can also be connected to the exhaust manifold 24 as is known, which provides boosted pressure via a boost pressure line 30 to a charge air cooler 32, which cools the gas discharged by the turbocharger 28 prior to being delivered into the intake manifold 22 to boost the air pressure in the intake manifold 22.

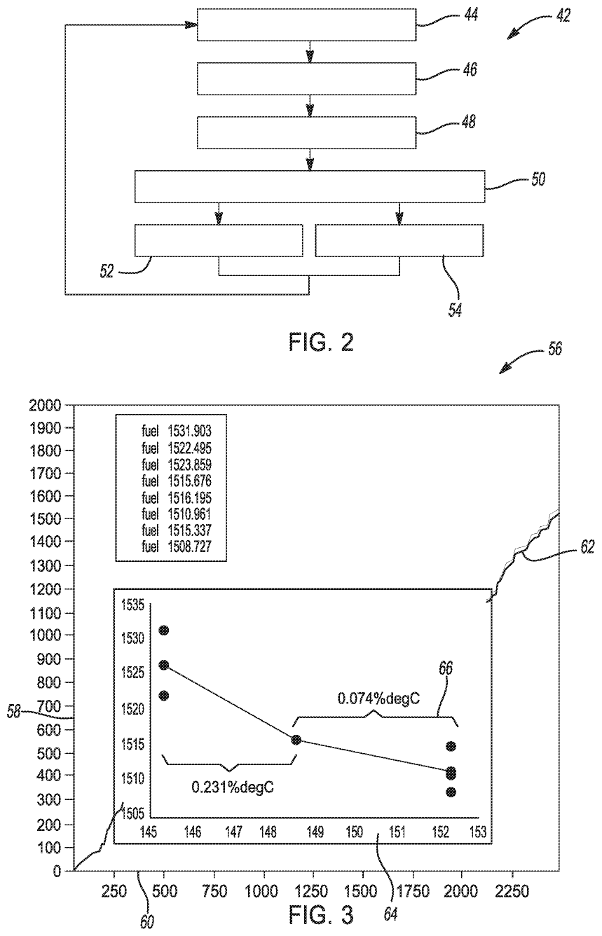

A control device such as an engine controller 34 receives signals from multiple sources and outputs control signals which control operation of the engine 12. One of the signal sources for the engine controller 34 can be a nitrogen oxide (NOx) sensor 36. Engine NOx output passing through the exhaust line 26 is sensed by the NOx sensor 36 which converts NOx output to an electrical output signal for transmission to the engine controller 34. If the NOx sensor 36 is not available or in addition to the signal output from the NOx sensor 36 the engine controller 34 can also calculate an estimated NOx output using data saved in a memory 37 such as one or more NOx lookup tables. The engine controller 34 or a similar controller is used to control delivery of an engine coolant from a coolant system 38 of known design to coolant jackets 40 of the cylinders 14. As will be described in greater detail in reference to FIG. 2 an algorithm is used to calculate and change a coolant target temperature for the coolant delivered to the coolant jackets 40 which incorporates NOx values determined from sensor signals received from the NOx sensor 36, or which are estimated by the engine controller 34 using the algorithm.

According to several aspects, the NOx sensor 36 is introduced into the engine exhaust line 26 and produces signals which correlate to engine output conditions at a peak cylinder temperature. NOx sensor 36 output signals are therefore converted in the engine controller 34 to determine peak cylinder temperatures. The peak cylinder temperatures are applied to determine if an adjustment to the set point temperature for the thermal system wall temperature can be made to maximize efficiency under multiple different operating conditions. For example, by utilizing an output from the NOx sensor 36 a determination can be performed if peak cylinder temperature is rising or if the thermal benefits achievable by changing the set point temperature of the engine coolant which allow higher cylinder temperatures to minimize or eliminating engine knock or allowing localized boiling of the engine coolant have been maximized. If the NOx sensor 36 is not available, the signals produced by the NOx sensor 36 can also be simulated using a NOx sensor model using lookup table data saved in a memory.

Referring to FIG. 2 and again to FIG. 1, the engine thermal target setpoint system 10 can adjust a thermal set point of the engine coolant to sustain, raise or lower cylinder wall temperatures to maximize fuel efficiency, including differences due to different fuel properties and different ambient conditions. An algorithm 42 in a first step 44 identifies an initial NOx integral at a measured or initial cylinder wall temperature, and an initial thermal set point of the engine coolant. In a second step 46 a command to change the cylinder temperature and therefore the thermal set point of the engine coolant is initiated. In a following third step 48, a new NOx integral at a new cylinder wall temperature with a modified thermal set point of the engine coolant is identified. In a fourth step 50 a comparison is performed to identify: 1) is (new NOx integral—initial NOx integral)>(predefined minimum threshold)?; AND 2) is (new NOx integral—initial NOx integral)<(predefined maximum threshold)?.

If the response to queries in step 50 is YES, in a step 52 a command signal is generated to decrease the thermal set point of the engine coolant. This decrease in the thermal set point of the engine coolant reduces the cylinder wall temperature to prevent engine knock and therefore to protect system hardware.

If the response to queries in step 50 is NO, in a step 54 a command signal is generated to increase the thermal set point of the engine coolant. This increase in the thermal set point of the engine coolant increases the cylinder wall temperature to increase fuel economy while minimizing the potential for engine knock and localized boiling of the engine coolant in the coolant jackets 40.

During vehicle engine operation the algorithm 42 continuously loops on a predetermined time interval. The algorithm 42 identifies if further improvement in fuel economy is available by increasing cylinder wall temperature, or if cylinder wall temperature has reached a maximum allowable wall temperature based on NOx production requiring additional engine coolant flow to reduce a temperature of the coolant in the coolant jackets 40.

Referring to FIG. 3 and again to FIGS. 1 and 2, a graph 56 identifies a range of fuel combustion temperatures 58 in centigrade compared to a range of cylinder wall temperatures 60 in centigrade for multiple curves 62 defining various integrated fuel data. Graph 56 also includes a range of coolant wall temperatures 64 which indicate over a portion 66 of the range of coolant wall temperatures 64 that an integrated NOx increased 20% while efficiency increased 0.74% which agrees with Carnot predictions. Graph 56 therefore indicates a correlation exists for various fuel types between NOx and fuel efficiency.

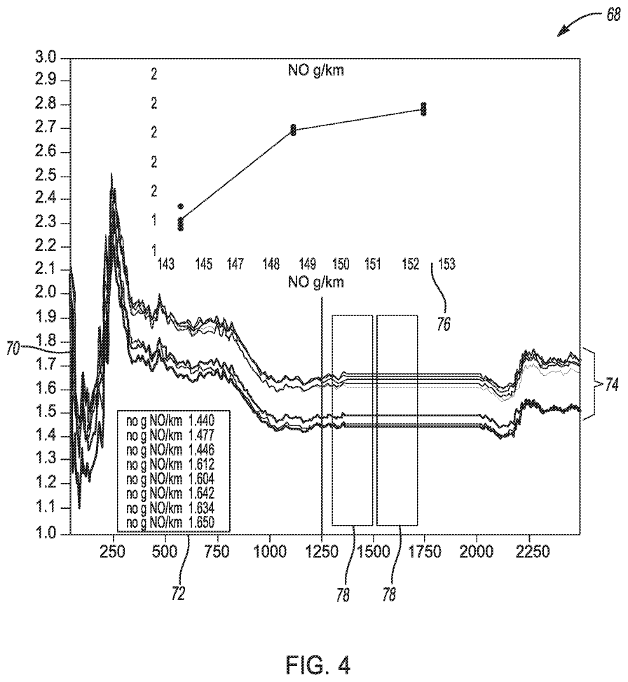

Referring to FIG. 4 and again to FIGS. 1 through 3, a graph 68 provides a range of NOx levels 70 compared to a range of cylinder wall temperatures 72 in centigrade similar to the range of cylinder wall temperatures 60 previously discussed in reference to FIG. 3. Multiple coolant outlet target temperature curves 74 having exemplary ranges of 90 degrees centigrade, 95 degrees centigrade and 100 degrees centigrade are also presented. Graph 68 also includes a range of coolant wall temperatures 76 compared to NOx levels. It has been found that thermal efficiency is maximized as the relationship between peak cylinder temperature asymptotes in an engine if the exhaust temperature remains constant.

To maximize thermal efficiency NOx production is used with the engine thermal target setpoint system 10 because NOx production of the engine 12 is a strong function of peak cylinder wall temperature. This relationship has been found to be directly proportional. For example, for every approximate +50C temperature increase in cylinder wall temperature NOx production is doubled. By tracking NOx changes the engine thermal target setpoint system 10 can calculate corresponding cylinder wall maximum temperatures. Predicted ideal cylinder wall temperature targets 78 can thereby be determined based on the integrated NOx changes and cylinder wall temperatures and can be controlled by changing coolant flow to the cylinder walls. The predicted ideal cylinder wall temperature targets 78 are based on integrated NOx changes defined as differences between the new NOx integral and the initial NOx integral.

The engine thermal target setpoint system 10 provides the ability to read or predict NOx relative to engine output conditions. Either relative changes can be predicted using data saved in a memory such as in lookup tables of the engine controller 34, or measured changes sensed by the NOx sensor 36 can be used. The engine thermal target setpoint system 10 is not focused on an absolute accuracy of the NOx sensor 36 because the trend or change in cylinder wall temperature is also related to a type of fuel used such as the fuel octane rating and the type and amount of fuel additives such as ethanol fuel blend, plus vehicle ambient conditions. The engine thermal target setpoint system 10 therefore uses an algorithm to determine and change cylinder wall temperature set points based on the above conditions. The system 10 also permits predictions of engine fuel efficiency available based on Carnot principles.

An engine thermal target setpoint system of the present disclosure offers several advantages. By integrating NOx values at various engine output conditions and comparing to actual or predicted cylinder wall temperatures, active thermal controls can be adjusted to increase engine efficiency while minimizing the potential for engine knock and localized coolant boiling at the cylinder walls.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for controlling an engine thermal target setpoint, comprising:
identifying in a first step an initial NOx integral at a cylinder wall temperature and a thermal set point of an engine coolant;
initiating a command in a second step to change the cylinder wall temperature and to change the thermal set point of the engine coolant; and
creating in a third step a new NOx integral at a new cylinder wall temperature and a modified thermal set point of the engine coolant.

2. The method of claim 1, further including determining in a fourth step if (the new NOx integral minus the initial NOx integral) is greater than a predefined minimum threshold.

3. The method of claim 2, further including determining in the fourth step if (the new NOx integral minus the initial NOx integral) is less than a predefined maximum threshold.

4. The method of claim 3, further including limiting the predefined maximum threshold to prevent localized boiling of the engine coolant in a cylinder cooling jacket and knock of an engine.

5. The method of claim 4, further including generating a command signal to decrease the thermal set point of the engine coolant if a response to the determinations performed in the fourth step is YES.

6. The method of claim 4, further including generating a command signal to increase the thermal set point of the engine coolant if a response to the determinations performed in the fourth step is NO.

7. The method of claim 1, further including incorporating an output signal from a NOx sensor to calculate the cylinder wall temperature, the initial NOx integral, and the new NOx integral.

8. The method of claim 1, further including estimating a NOx level output from an engine to calculate the cylinder wall temperature.

9. The method of claim 1, further including tracking changes to the NOx integral and applying the changes to the NOx integral to data saved in a memory to calculate cylinder wall maximum temperatures.

10. The method of claim 9, further including generating predicted ideal cylinder wall temperature targets based on the changes to the NOx integral defined as differences between the new NOx integral and the initial NOx integral.

11. A method for controlling an engine thermal target setpoint, comprising:
identifying in a first step an initial NOx integral at an initial cylinder wall temperature and a thermal set point of an engine coolant;
initiating a command in a second step to change the initial cylinder wall temperature and to change the thermal set point of the engine coolant;
creating in a third step a new NOx integral at a new cylinder wall temperature and a modified thermal set point of the engine coolant; and
comparing in a fourth step:
is (the new NOx integral minus the initial NOx integral) greater than a predefined minimum threshold; and
is (the new NOx integral minus the initial NOx integral) less than a predefined maximum threshold.

12. The method of claim 11, further including calculating the initial cylinder wall temperature using NOx data saved in a memory.

13. The method of claim 12, further including predicting the modified thermal set point using NOx data from the memory.

14. The method of claim 11, further including calculating the initial cylinder wall temperature, the initial NOx integral, the new NOx integral and the modified thermal set point using output signals from a NOx sensor and NOx data saved in a memory.

15. The method of claim 11, wherein the initial NOx integral and the new NOx integral are directly proportional to a peak cylinder wall temperature.

16. The method of claim 11, further including repeating the first step, the second step, the third step and the fourth step to identify if further improvement in fuel economy is available by increasing a cylinder wall temperature.

17. The method of claim 16, further including identifying if the cylinder wall temperature has reached a maximum allowable cylinder wall temperature based on a NOx level produced by an engine.

18. A system controlling an engine thermal target setpoint, comprising:
an initial NOx integral determined at a cylinder wall temperature and a thermal set point of an engine coolant;
a command generated to change the cylinder wall temperature and to change the thermal set point of the engine coolant;
a new NOx integral at a new cylinder wall temperature and a modified thermal set point of the engine coolant created following the command;
a first determination identifies if the new NOx integral minus the initial NOx integral is greater than a predefined minimum threshold; and
a second determination identifies if the new NOx integral minus the initial NOx integral is less than a predefined maximum threshold.

19. The system of claim 18, further including a NOx sensor generating an output signal defining a NOx level in an engine exhaust, the initial NOx integral, and the new NOx integral.

20. The system of claim 18, further including an engine controller calculating an estimated NOx output using data saved in a memory.
